(19) United States
(12) Patent Application Publication
(10) Pub. No.: US 2009/0173213 A1
(43) Pub. Date: Jul. 9, 2009

(54) Music Score Recognizer and Its Applications

(76) Inventors: Ming Jiang, Alpharetta, GA (US); Min Shi, Alpharetta, GA (US)

Correspondence Address: Ming JIANG, 455 Barnesley Lane, Alpharetta, GA, 30022, US

(21) Appl. No.: 11/971,903

(22) Filed: Jan. 9, 2008

(51) Int. Cl. G09B 15/00

(52) U.S. Cl. 84/484

(57) ABSTRACT

A music playing evaluation system, comprising: (i) an input, (ii) a real-time digital signal processing system having an A/D converter, a signal storage, a volume analyzer, a pitch analyzer, a tempo analyzer and a music notes recognizer, (iii) an original score storage, (iv) a played score storage, (v) a performance analyzer, (vi) a music output interface, and (vii) a music display interface, wherein the played music is analyzed, and the amplitude information, the pitch information and the tempo information are extracted and sent to the music notes recognizer and the played music score is obtained. The played music score is compared with the original music score in real time based on the amplitude information, the pitch information and the tempo information extracted from the played music so as to generate a performance evaluation report displayed on the music display interface.

### FIELD OF THE PRESENT INVENTION

The present invention generally relates to music score recognizer. More particularly, the present invention relates to music score recognizer and using the same to facilitate the learning of music.

### BACKGROUND OF THE PRESENT INVENTION

This invention relates to digital music signal processing, and more specifically, to automatically recognize music score from a section of played music, to carry out a comparison between the standard score to be played and played score, and to provide an interactive and quantitative measure to make music learning process easier and exciting.

Electronic display stands have been proposed, which can advance musical notes without the interruption of a conductor and/or musician. U.S. Pat. No. 5,760,323, entitled “NETWORKED ELECTRONIC MUSIC DISPLAY STANDS”, by Romero et al., proposed an electronic display stand which can be controlled by remote mechanical actuation, the sound of musical notes, or a timed interval. Several of these devices can be networked to display music to several musicians. U.S. Pat. No. 6,483,019, entitled “MUSIC ANNOTATION SYSTEM FOR PERFORMANCE AND COMPOSITION OF MUSICAL SCORES”, proposed a FreeHand System that uses internet to download music, to display music, and allow modification or annotation by a conductor or musician. This invention further proposed a FreeHand System (FHS) file format.

The FreeHand System is able to receive music scores from a plurality of networked computers, the internet, and is able to display music scores continuously with a foot pedal to change pages. This advance feature eliminates the need to periodically cease playing music instrument to turn sheet music pages. However, the musicians/conductors still have to divert their attentions to the end of a music sheet and to press the foot pedal at a particular time. Although, the sheet music pages can be turned by a predetermined time interval, when musicians/conductors play/conduct music, they interpret the music on their own ways and do not necessarily follow the timing exactly on the sheet music page. It makes the changing of sheet music pages at a predetermined interval less effective, sometimes useless. Therefore, the changing of music sheet pages was still not fully automatic.

Also lacked in the prior art is a music learning tool that enable musicians/music students to evaluate their performance in an interactive and quantitative measure during their practice session.

Therefore, a heretofore unaddressed need exists in the art to address the aforementioned deficiencies and inadequacies.

### SUMMARY OF THE PRESENT INVENTION

The present invention, in one aspect, related to a system for evaluating music performance. In one embodiment, the key component of the system for evaluating music performance is a digital signal processing system. The digital signal processing system has: (i) an A/D converter coupled to the input for converting the played music in the analog form to a digital form, (ii) a signal storage for storing the played music in the digital form received from the A/D converter, (iii) a volume analyzer adapted for extracting the amplitude information from the played music stored in the signal storage, (iv) a pitch analyzer adapted for extracting the pitch information from the played music stored in the signal storage, (v) a tempo analyzer adapted for extracting the tempo information from the played music stored in the signal storage, and (vi) a music notes recognizer adapted for recognizing the music notes from the played music based on the information received from the volume analyzer, the pitch analyzer, and the tempo analyzer.

The system for evaluating music performance also has: (i) an input adapted for receiving played music to be evaluated in an analog form, (ii) a real-time digital signal processing system adapted for converting the received played music to a played score, (iii) an original score storage adapted for storing an original music score, (iv) a played score storage adapted for storing a played music score, (v) a performance analyzer coupled to the original score storage and the played score storage for comparing the original music score and the played music score so as to obtain statistics of the performance, (vi) a music output interface coupled to the original score storage and the played score storage for playing back a selected music original music score and/or the played music score, and (vii) a music display interface coupled to the original score storage, the played score storage and performance analyzer for displaying the original music score, the played music score, an overlay of the original music score with the played music score, and a performance evaluation.

The played music is received from the input, digitized by the A/D converter and processed by the volume analyzer, the pitch analyzer and tempo analyzer. The amplitude information, the pitch information and the tempo information extracted from the played music is sent to the music notes recognizer and the played music score is obtained from an output of the music notes recognizer, and stored in the played score storage. The played music score is compared with the original music score in real time based on the amplitude information, the pitch information and the tempo information extracted from the played music so as to generate a performance evaluation report displayed on the music display interface.

In one embodiment, the digital signal processing system of the music performance evaluation system further includes a CPU having a command input for receiving operation control signal. The CPU is coupled to the signal storage, the volume analyzer, the pitch analyzer, and the tempo analyzer, the music notes recognizer, the original score storage, the played score storage and performance analyzer. The sources of the operation control signal include a USB port, a keyboard, a touch screen panel, a wireless receiver, a Bluetooth receiver, and/or a port connecting to the internet.

In one embodiment, the operation control signal controls the operation of a plurality of storage, including the digitized music signal storage, the original score storage, and the played score storage. The operation control signal further controls the operation of the volume analyzer, the pitch analyzer, the tempo analyzer, the music notes recognizer, the performance analyzer, the music output interface, and the music display interface.

In one embodiment, the music display interface is used to display the original music score, the played music score, the overlay of the original music score and played music score showing difference between the original music score and the played music score, and the performance evaluation report.

In another aspect, the present invention relates to a system for indicating music playing progress. In one embodiment, the key component of the system for indicating music playing progress is the digital signal processing system. The digital signal processing system has: (i) an A/D converter coupled to the input for converting the played music in the analog form to a digital form, (ii) a signal storage for storing the played music in the digital form received from the A/D converter, (iii) a volume analyzer adapted for extracting the amplitude information from the played music stored in the signal storage, (iv) a pitch analyzer adapted for extracting the pitch information from the played music stored in the signal storage, (v) a tempo analyzer adapted for extracting the tempo information from the played music stored in the signal storage, and (vi) a music note recognizer adapted for recognizing the music notes from the played music based on the information received from the volume analyzer, the pitch analyzer, and the tempo analyzer.

The system for indicating music playing progress also includes: (i) an input adapted for receiving a played music in analog form, (ii) a real-time digital signal processing system adapted for converting the received played music to a played score, (iii) an original score storage adapted for storing an original music score, (iv) a played score storage adapted for storing a played music score, (v) a progress comparator coupled to the original score storage, the played score storage for matching the played score to the original score and indicating the music playing progress through a progress indicator based on the information received from the volume analyzer, the pitch analyzer, and the tempo analyzer, and (vi) a music display interface adapted for displaying the original score, the played score, and the music playing progress.

The played music is received from the input, the played music is digitized by the A/D converter, processed by the volume analyzer, the pitch analyzer, and tempo analyzer. The amplitude information, the pitch information and the tempo information extracted from the played music is sent to the music notes recognizer and played music score is obtained from an output of the music notes recognizer, and stored in the played score storage.

The played score is then compared with the original score in real time based on the amplitude information, the pitch information and the tempo information extracted from the played music. A music playing progress is displayed on the music display interface in real time.

In one embodiment, the digital signal processing system of the system for indicating music playing progress further has a CPU with a command input for receiving operation control signal. The CPU is coupled to the signal storage, the volume analyzer, the pitch analyzer, and the tempo analyzer, the music notes recognizer, the original score storage, the played score storage and the progress comparator.

In one embodiment, the sources of the operation control signal includes a USB port, a keyboard, a touch screen panel, a wireless receiver, a Bluetooth receiver, and/or a port connecting to the internet.

In one embodiment, the operation control signal controls the operation of a plurality of storages. The plurality of storages comprises the digitized music signal storage, the original score storage, and the played score storage. The operation control signal also controls the operation of the volume analyzer, the pitch analyzer, the tempo analyzer, the music notes recognizer, the progress comparator, and the music display interface.

In one embodiment, the music display interface is used to display the original score, the played score, and a music playing progress. The music playing progress is displayed by: (i) a moving bar displayed on top of the original score, or between the tremble notes and bass notes of the original score, (ii) a flashing dots displayed on top of the original score, or between the tremble notes and bass notes of the original score, and/or (iii) the played score.

In one embodiment, the music playing progress indicator can also be used as a trigger to automatically turn a sheet music page of the original score displayed on the music display interface.

In yet another aspect, the present invention relates to a method for evaluating music performance. In one embodiment, the method includes the steps of: (i) recording a played music, (ii) processing the played music to extracting the amplitude information, the pitch information and tempo information of the played music, (iii) recognizing the music notes of the played music from the extracted the amplitude information, the pitch information and tempo information of the played music, wherein the music notes of the played music includes a played music score, (iv) comparing the played music score with the original music score to obtain statistics of the performance, and (v) displaying the original music score, the played music score, the overlay of the original music score and played music score showing difference between the original music score and the played music score, and the performance evaluation report.

In one embodiment, the step of recording includes the steps of: (i) receiving the played music in an analog form, (ii) converting the received played music into a digital form, and (iii) storing the converted played music.

In one embodiment, the method also includes the step of playing back the played music score or the original music score.

In one embodiment, the method further includes the step of storing the original music score of a selected music.

In one embodiment, the method includes the step of displaying a music playing progress in real time by a progress indicator. When music playing progress is displayed, the music playing progress is displayed by: (i) a moving bar displayed on top of the original score, or between the tremble notes and bass notes of the original score, (ii) a flashing dots displayed on top of the original score, or between the tremble notes and bass notes of the original score, and (iii) the played score.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 shows a block diagram of a music performance evaluator according to one aspect of the present invention;

FIG. 2 shows a flowchart of a music performance evaluation system according to one embodiment of the present invention;

FIG. 3 shows a flowchart of the music performance evaluation system according to one embodiment of the present invention;

FIG. 4A shows a portion of original sheet music and its corresponding desired volume as displayed on a display interface, and FIG. 4B shows a portion of played music and its corresponding actual volume as displayed on the display interface according to one embodiment of the present invention;

FIG. 5 shows a portion of the played music is overlaid on a corresponding portion of original music as a comparison of the portion of original music to be played and the portion of played according to one embodiment of the present invention.

FIG. 6 shows an exemplary evaluation sheet indicating an overall evaluation of the performance, as well as the detailed statistics of the played music showing specifically the performance in three major categories—volume, pitch and tempo, according to one embodiment of the present invention.

FIG. 7 shows a block diagram of a music playing progress indicator according to another aspect of the present invention; and

FIG. 8 shows two exemplary displays of music playing progress indicator according to one embodiment of the present invention.

### DETAILED DESCRIPTION OF THE PRESENT INVENTION

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

### Music Performance Evaluator

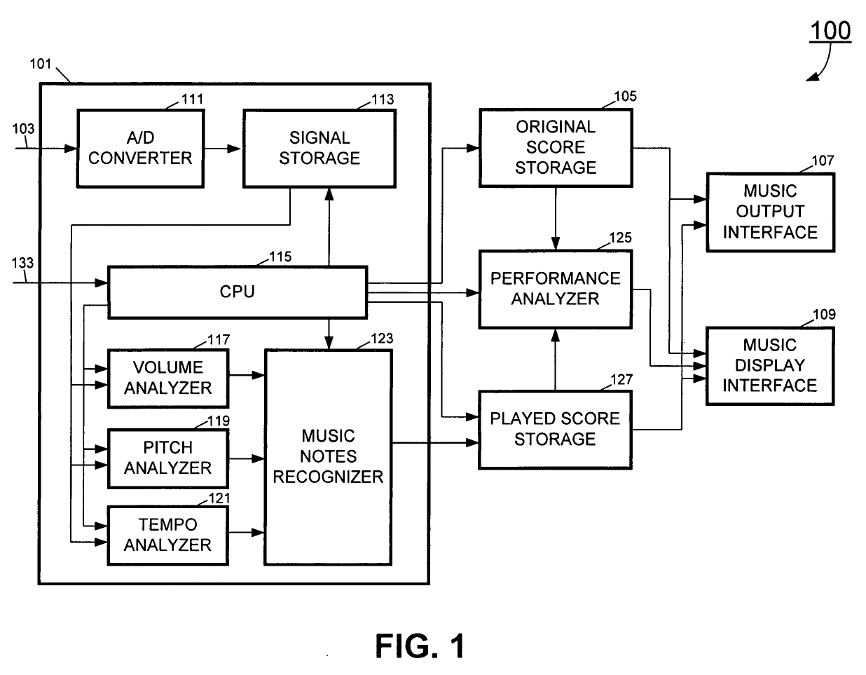

The present invention relates to a music performance evaluation system 100 according to one embodiment of the present invention. Referring now to FIG. 1, the music performance evaluation system 100 has: (i) an input 103 adapted for receiving played music to be evaluated in an analog form, (ii) an real-time digital signal processing system 101 adapted for converting the received played music to a played score, (iii) an original score storage 105 adapted for storing an original music score, (iv) a played score storage 127 adapted for storing a played music score, (v) a performance analyzer 125 coupled to the original score storage 105 and the played score storage 127 for comparing the original music score and the played music score so as to obtain statistics of the performance, (vi) a music output interface 107 coupled to the original score storage 105 and the played score storage 127 for playing back a selected music original music score and/or the played music score, and (vii) a music display interface 109 coupled to the original score storage 105, the played score storage 127 and performance analyzer 125 for displaying the original music score, the played music score, an overlay of the original music score with the played music score, and a performance evaluation.

In one embodiment, the digital signal processing system 101 includes: (i) an A/D converter 111 coupled to the input 103 for converting the played music in the analog form to a digital form, (ii) a signal storage 113 for storing the played music in the digital form received from the A/D converter 111, (iii) a volume analyzer 117 adapted for extracting the amplitude information from the played music stored in the signal storage 103, (iv) a pitch analyzer 119 adapted for extracting the pitch information from the played music stored in the signal storage 103, (v) a tempo analyzer 121 adapted for extracting the tempo information from the played music stored in the signal storage 103; and (vi) a music notes recognizer 123 adapted for recognizing the music notes from the played music based on the information received from the volume analyzer 117, the pitch analyzer 119, and the tempo analyzer 121.

In one embodiment, the digital signal processing system 101 further includes a CPU 115 with a command input 133 for receiving operation control signal. The CPU 115 is coupled to the signal storage 103, the volume analyzer 117, the pitch analyzer 119, and the tempo analyzer 121, the music notes recognizer 123, the original score storage 105, the played score storage 127 and performance analyzer 125.

In one embodiment, the operation control signal is received from a USB port, a keyboard, a touch screen panel, a wireless receiver, a Bluetooth receiver, and/or a port connecting to the internet. The operation control signal controls the operation of a plurality of storage. The plurality of storages includes the digitized music signal storage 113, the original score storage 105, and the played score storage 127. The operation control signal also controls the operation of the volume analyzer 117, the pitch analyzer 119, the tempo analyzer 121, the music notes recognizer 123, the performance analyzer 125, the music output interface 107, and the music display interface 109. The music display interface 109 is used to display the original music score, the played music score, the overlay of the original music score and played music score showing difference between the original music score and the played music score, and the performance evaluation report.

The played music is received from the input 103, digitized by the A/D converter 111 and processed by the volume analyzer 117, the pitch analyzer 119 and tempo analyzer 121. The amplitude information, the pitch information and the tempo information extracted from the played music is sent to the music notes recognizer 123 and the played music score is obtained from an output of the music notes recognizer 123, and stored in the played score storage 127. The played music score is then compared with the original music score in real time based on the amplitude information, the pitch information and the tempo information extracted from the played music so as to generate a performance evaluation report displayed on the music display interface 109.

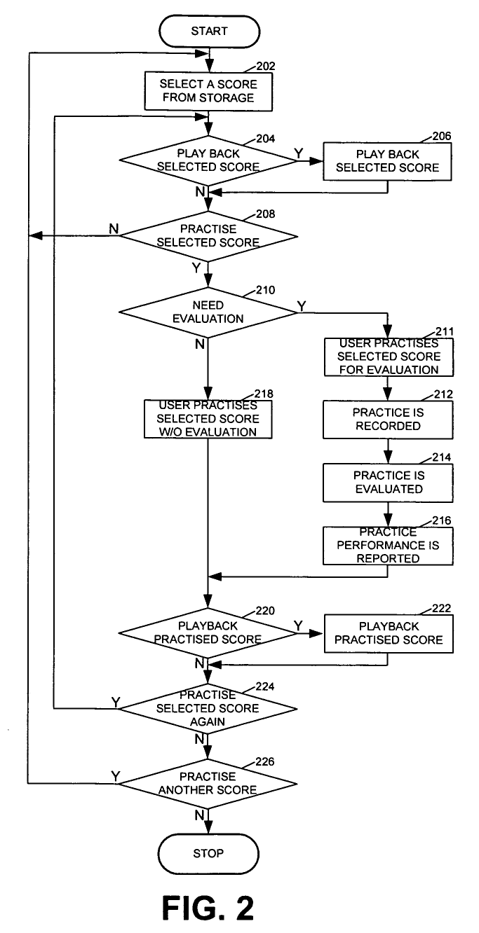

Referring now to FIG. 2, a flowchart of a music performance evaluation system is shown according to one embodiment of the present invention. The music performance evaluation process starts at the step 202 of selecting a score by a user from the original score storage 105 as shown in FIG. 1. If the user desires to listen to the selected music, he/she can choose to play back the selected music at step 204 and followed by step 206 for playing back the music of the selected score. Otherwise, he/she can take the step of 208 to decide whether the user wishes to practice the selected score. If he/she decide not to practice the selected music score, then he/she goes back to step 202. Otherwise, he/she needs to decide whether an evaluation of the practice is needed at step 210. If yes, then the user practices the selected music for evaluation at the step 211. Then the practice is recorded at step 212, is evaluated at the step 214, and a practice performance is reported at the step 216. If the user decides an evaluation of the practice is not needed at step 210, then he/she takes the step 218 to practice the selected music without an evaluation.

The next step for both steps 218 and 216 is step 220 where the user can decide if a play back of the practiced music. If yes, then the step 222 is taken to play back the practiced music and then goes to step 224. If not, then the step 224 is directly taken to decide the user desires to continue practicing the selected score. If yes, the step 204 will be taken. Otherwise, if not, then the user is to decide whether he/she will practice another score at step 226. If he/she decides to continue with another score, then the step 202 is taken. Otherwise, the practice session is terminated at the stop.

Some or all of the decisions (steps 204, 208, 210, 220, 224, and 226) during the practice can be set as default, and user has the option to change the options at any time. User can also decide the number of iterations of practice he/she wishes to accomplish during the practice, so when the number of iterations of practice is reached, the practice can be terminated automatically.

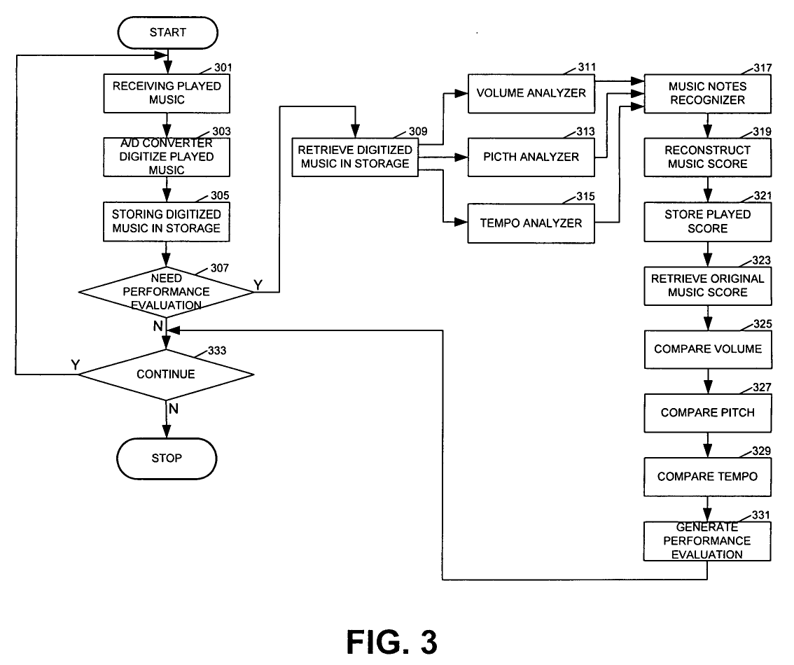

Referring now to FIG. 3, a flowchart of the music performance evaluation system is presented according to one embodiment of the present invention. At the step 301, the played music (the practiced music) is received at the input 103 as shown in FIG. 1. At the step 303, the A/D converter 111 of the digital signal processing system 101 digitizes the played music. At the step of 305, the digitized played music is stored in the signal storage 113. At the step 307, the user needs to decide whether the practiced music or played music is to be evaluated. If no, the step 333 is taken to decide whether to continue the practice. If the user no longer wishes to continue the practice, then the practice session is terminated at the stop. If the user decides to continue, then the step 301 at the beginning is taken to start over.

If the user decides at step 307 to have the practice performance evaluated, the step 309 is taken. At step 309, the digitized played music signal is retrieved from the signal storage 113 as shown in FIG. 1. The signal is sent to a volume analyzer at step 311, a pitch analyzer at step 313, and a tempo analyzer 315 to be analyzed. The results of the analysis: the amplitude information, the pitch information and the tempo information are sent to a music notes recognizer to be processed at the step 317. In real-time, the music notes are recognized one by one, and they are combined at the step 319 to reconstruct the played music score. Then the played music score is stored at the step 321 in the played score storage 127 as shown in FIG. 1. The original music score is retrieved at the step 323. The original music score and played music score are compared at the step 325 for amplitude information, at the step 327 for pitch information and at the step 329 for tempo information. And a performance evaluation report is generated at the step 331. After the evaluation report is reported, the step 333 is taken to decide whether to continue the practice. If yes, the evaluation process starts over again. If no, the evaluation process is terminated at the stop.

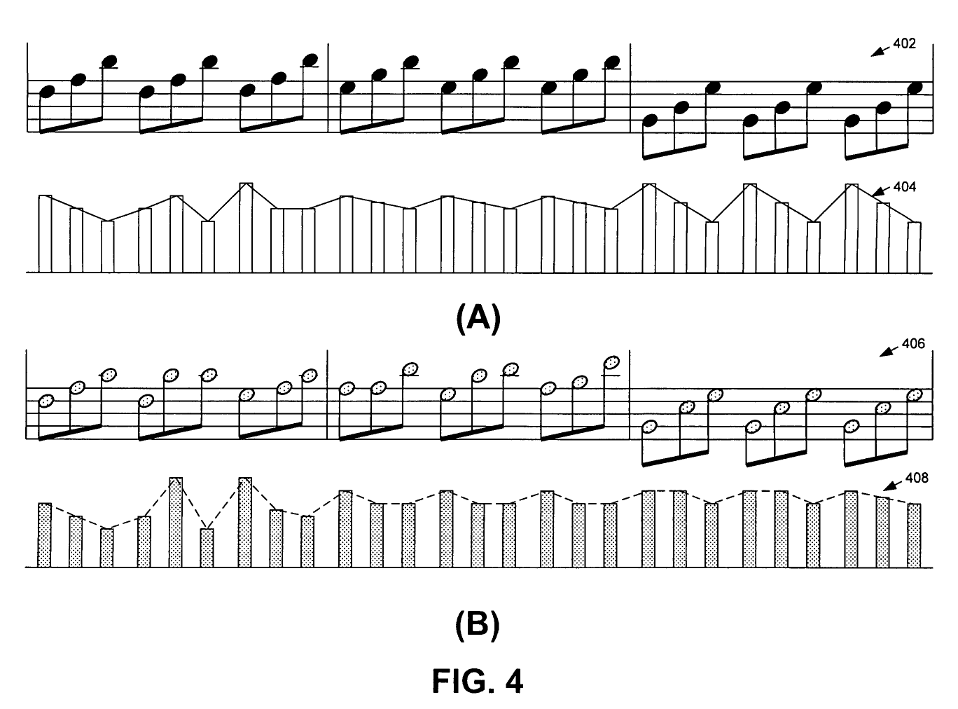

FIG. 4A shows a portion of original sheet music 402 and its corresponding desired volume 404 as displayed on a display interface 109 as shown in FIG. 1, according to one embodiment of the present invention.

FIG. 4B shows a portion of played music 406 and its corresponding actual volume 408 as displayed on the display interface 109 as shown in FIG. 1, according to one embodiment of the present invention.

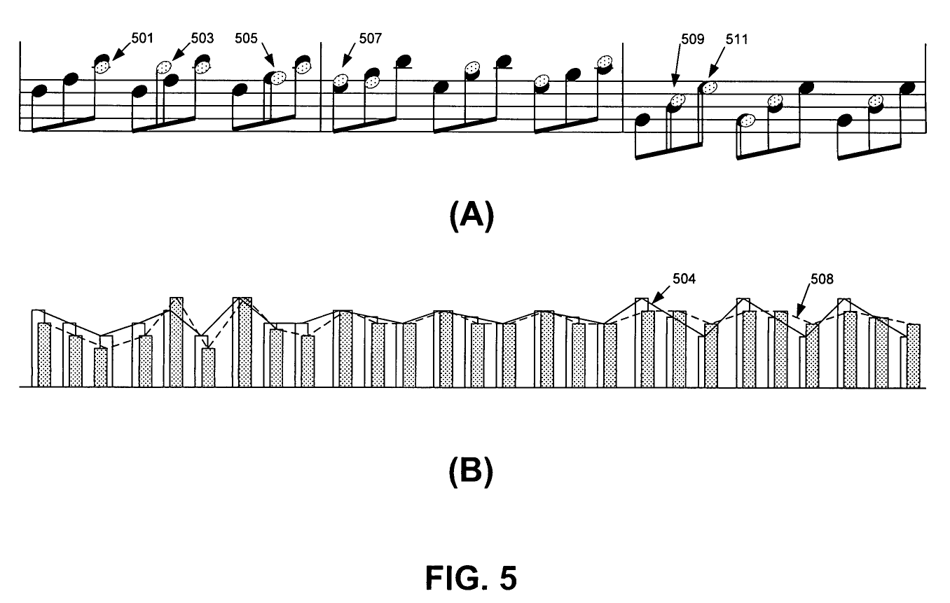

When FIG. 4A and FIG. 4B are overlaid on top of each other, the result is shown in FIG. 5 according to one embodiment of the present invention. A portion of the played music is overlaid on a corresponding portion of original music as a comparison of the portion of original music to be played and the portion of played music. The FIG. 5A shows the differences of pitch information and tempo information between the portion of original music to be played and the portion of played music. The FIG. 5B shows the differences of amplitude information between the portion of original music 504 to be played and the portion of played music 508.

In FIG. 5A, 501 shows that the played music note is one whole step below the desired original music note but on the correct beat. 503 shows that the played music note is two whole steps higher than the desired original music note, and 1/16 beat ahead of the correct beat. 503 shows that the played music note is the same as the desired original music note, and 1/16 beat behind the correct beat. 507 shows that the played music note is one whole step higher than the desired original music note but on the correct beat. 509 shows that the played music note is one whole step higher than the desired original music note, and 1/32 beat behind the correct beat. 511 shows that the played music note is same as the desired original music note, and 1/32 beat behind of the correct beat. These differences are obtained from the comparison between the original music score and played music score, and statistics are obtained with great accuracy.

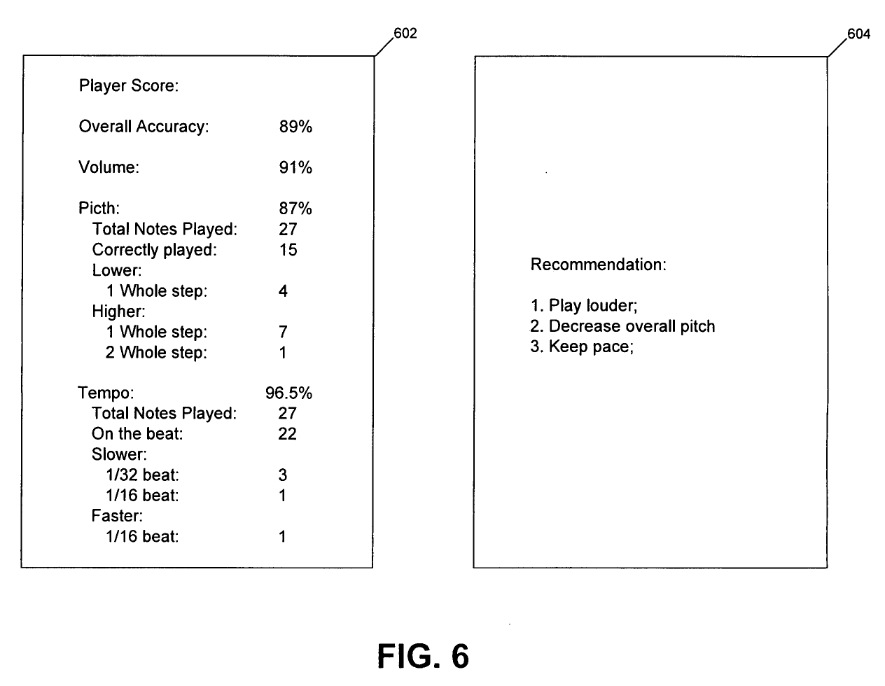

An exemplary evaluation sheet indicating an overall evaluation of the performance, as well as the detailed statistics of the played music showing specifically the performance in three major categories—volume, pitch and tempo is shown in FIG. 6 according to one embodiment of the present invention. An overall accuracy score of 89% is given for the section of the performance. FIG. 5 shows that there are 27 notes played in this section. As far as the pitch is concerned, 15 of these 27 notes were played correctly. FIG. 6 shows an exemplary report 602, where four notes were played one whole step lower than the original score, seven notes were played one whole step higher than the original score, and one note was played one whole step lower than the original score. The overall score of the tempo is 96.5% which was obtained by weighted average of mistakes the user made during the practice. There were 22 notes played on the correct beat. Five notes were played incorrectly, where three notes were played about 1/32 beat too slow, one note was played about 1/16 beat too fast, and one note was played about 1/16 beat too slow. The statistics provides the user a quantitative measure of overall playing accuracy. It will help user to improve his/her practice.

A recommendation sheet 604 is provided as an example. These recommendations are based on the quantitative accuracy measure. Further recommendations can be made when further details of the played music are extracted.

### Music Playing Progress Indicator

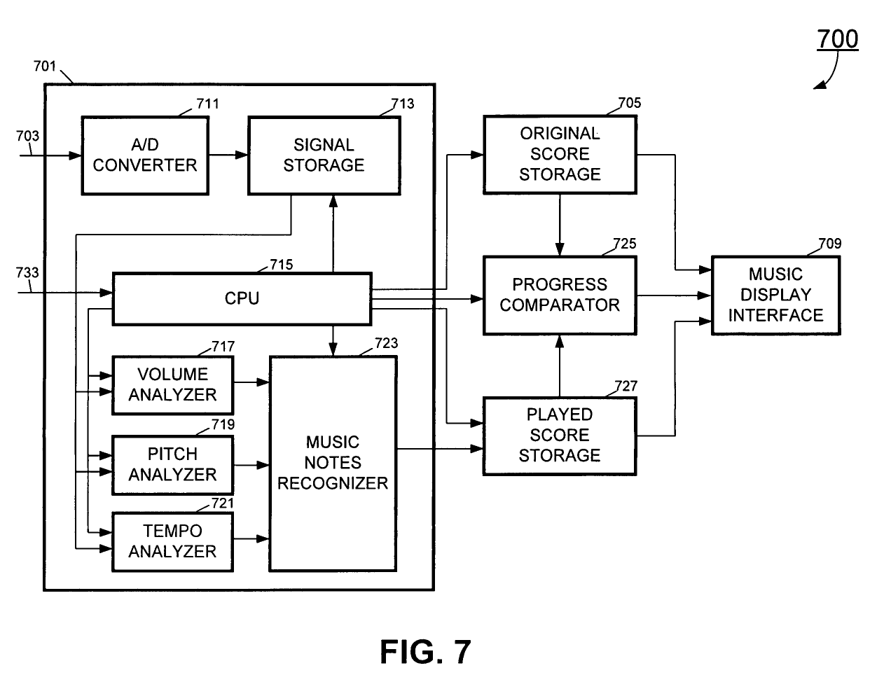

In another aspect, the present invention relates to a music playing progress indicator 700. FIG. 7 shows a block diagram of the music playing progress indicator according to another aspect of the present invention.

In one embodiment, the key component of the music playing progress indicator 700 is a digital signal processing system 701. The digital signal processing system 701 has: (i) an A/D converter 711 coupled to the input 703 for converting the played music in the analog form to a digital form, (ii) a signal storage 703 for storing the played music in the digital form received from the A/D converter 711, (iii) a volume analyzer 717 adapted for extracting the amplitude information from the played music stored in the signal storage 703, (iv) a pitch analyzer 719 adapted for extracting the pitch information from the played music stored in the signal storage 703, (v) a tempo analyzer 721 adapted for extracting the tempo information from the played music stored in the signal storage 703, and (vi) a music note recognizer 723 adapted for recognizing the music notes from the played music based on the information received from the volume analyzer 717, the pitch analyzer 719, and the tempo analyzer 721.

The music playing progress indicator 700 also has: (i) an input 703 adapted for receiving a played music in analog form, (ii) an real-time digital signal processing system 701 adapted for converting the received played music to a played score, (iii) an original score storage 705 adapted for storing an original music score, (iv) a played score storage 727 adapted for storing a played music score, (v) a progress comparator 725 coupled to the original score storage 705, the played score storage 727 for matching the played score to the original score and indicating the music playing progress. The music playing progress is derived from the information received from the volume analyzer 717, the pitch analyzer 719, and the tempo analyzer 721, (vi) a music display interface 709 adapted for displaying the original score, the played score, and the music playing progress.

In one embodiment, the digital signal processing system 701 has: (i) an A/D converter 711 coupled to the input 703 for converting the played music in the analog form to a digital form, (ii) a signal storage 703 for storing the played music in the digital form received from the A/D converter 711, (iii) a volume analyzer 717 adapted for extracting the amplitude information from the played music stored in the signal storage 703, (iv) a pitch analyzer 719 adapted for extracting the pitch information from the played music stored in the signal storage 703, (v) a tempo analyzer 721 adapted for extracting the tempo information from the played music stored in the signal storage 703, and (vi) a music note recognizer 723 adapted for recognizing the music notes from the played music based on the information received from the volume analyzer 717, the pitch analyzer 719, and the tempo analyzer 721.

The played music is received from the input 703, the played music is digitized by the A/D converter 711, and processed by the volume analyzer 717, the pitch analyzer 719, and tempo analyzer 721. The amplitude information, the pitch information and the tempo information extracted from the played music is sent to the music notes recognizer 723 and played music score is obtained from an output of the music notes recognizer 723, and stored in the played score storage 727.

The played score is compared with the original score in real time based on the amplitude information, the pitch information and the tempo information extracted from the played music. The music playing progress is displayed on the music display interface 709 in real time.

The digital signal processing system 701 further includes a CPU 715 with a command input 733 for receiving operation control signal. The CPU 715 is coupled to the signal storage 703, the volume analyzer 717, the pitch analyzer 719, and the tempo analyzer 721, the music notes recognizer 723, the original score storage 705, the played score storage 727 and the progress comparator 725. The operation control signal is received from a USB port, a keyboard, a touch screen panel, a wireless receiver, a Bluetooth receiver, and/or a port connecting to the internet.

The operation control signal controls the operation of a plurality of storages. The plurality of storages includes the digitized music signal storage 713, the original score storage 705, and the played score storage 727. The operation control signal also controls the operation of the volume analyzer 717, the pitch analyzer 719, the tempo analyzer 721, the music notes recognizer 723, the progress comparator 725, and the music display interface 709.

In one embodiment, the music display interface 709 is used to display the original score, the played score, and the music playing progress. The music playing progress is displayed by: (i) a moving bar displayed on top of the original score, or between the tremble notes and bass notes of the original score, (ii) a flashing dots displayed on top of the original score, or between the tremble notes and bass notes of the original score, and/or the played score.

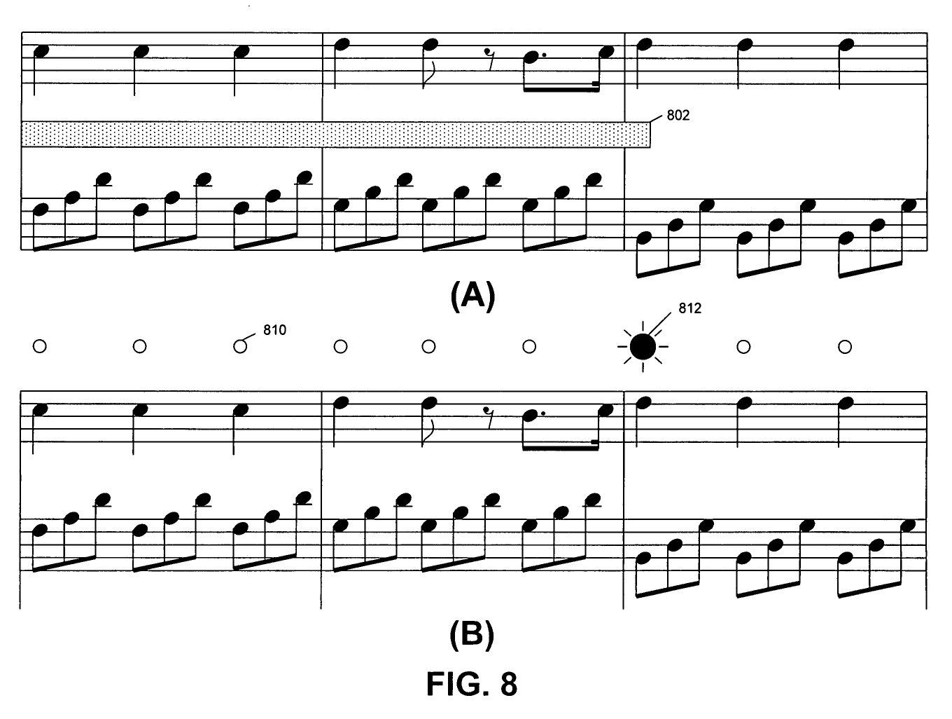

FIG. 8 shows two exemplary displays of music playing progress indicator according to one embodiment of the present invention. 802 shows the moving bar display. 810 and 812 are dots to display the music playing progress. 812 is a dot that is flashing indicating the music playing progress. The moving bar 802 can be placed on top of the tremble notes and the flashing dots 810 and 812 can also be shown in between the tremble and bass notes. The music playing progress can also be display by adding the music notes of current played music score.

In one embodiment, the music playing progress indicator can also be used as a trigger to automatically turn the sheet music page of the original score displayed on the music display interface 709.

In yet another aspect, the present invention relates to a method for evaluating music performance. In one embodiment, the method includes the steps of: (i) recording a played music, (ii) processing the played music to extracting the amplitude information, the pitch information and tempo information of the played music, (iii) recognizing the music notes of the played music from the extracted the amplitude information, the pitch information and tempo information of the played music, wherein the music notes of the played music includes a played music score, (iv) comparing the played music score with the original music score to obtain statistics of the performance, and (v) displaying the original music score, the played music score, the overlay of the original music score and played music score showing difference between the original music score and the played music score, and the performance evaluation report.

In one embodiment, the step of recording includes the steps of: (i) receiving the played music in an analog form, (ii) converting the received played music into a digital form, and (iii) storing the converted played music.

In one embodiment, the method also includes the step of playing back the played music score or the original music score.

In one embodiment, the method further includes the step of storing the original music score of a selected music.

In one embodiment, the method includes the step of displaying a music playing progress in real time by a progress indicator. When music playing progress is displayed, the music playing progress is displayed by: (i) a moving bar displayed on top of the original score, or between the tremble notes and bass notes of the original score, (ii) a flashing dots displayed on top of the original score, or between the tremble notes and bass notes of the original score, and (iii) the played score.

The above features as well as additional features and aspects of the present invention are disclosed herein and will become apparent from the foregoing description of preferred embodiments of the present invention.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A system for evaluating music performance, comprising:
A. an input adapted for receiving played music to be evaluated in an analog form;
B. a real-time digital signal processing system adapted for converting the received played music to a played score, wherein the digital signal processing system comprises:
a. an A/D converter coupled to the input for converting the played music in the analog form to a digital form;
b. a signal storage for storing the played music in the digital form received from the A/D converter;
c. a volume analyzer adapted for extracting the amplitude information from the played music stored in the signal storage;
d. a pitch analyzer adapted for extracting the pitch information from the played music stored in the signal storage;
e. a tempo analyzer adapted for extracting the tempo information from the played music stored in the signal storage; and
f. a music notes recognizer adapted for recognizing the music notes from the played music based on the information received from the volume analyzer, the pitch analyzer, and the tempo analyzer;
C. an original score storage adapted for storing an original music score;
D. a played score storage adapted for storing a played music score;
E. a performance analyzer coupled to the original score storage and the played score storage for comparing the original music score and the played music score so as to obtain statistics of the performance;
F. a music output interface coupled to the original score storage and the played score storage for playing back a selected music original music score and/or the played music score; and
G. a music display interface coupled to the original score storage, the played score storage and performance analyzer for displaying the original music score, the played music score, an overlay of the original music score with the played music score, and a performance evaluation,
wherein the played music is received from the input, digitized by the A/D converter and processed by the volume analyzer, the pitch analyzer and tempo analyzer, and the amplitude information, the pitch information and the tempo information extracted from the played music is sent to the music notes recognizer and the played music score is obtained from an output of the music notes recognizer, and stored in the played score storage; and
wherein the played music score is compared with the original music score in real time based on the amplitude information, the pitch information and the tempo information extracted from the played music so as to generate a performance evaluation report displayed on the music display interface.

2. The system of claim 1 wherein the digital signal processing system further comprises a CPU having a command input for receiving operation control signal, and wherein the CPU is coupled to the signal storage, the volume analyzer, the pitch analyzer, and the tempo analyzer, the music notes recognizer, the original score storage, the played score storage and performance analyzer.

3. The system of claim 2 wherein the sources of the operation control signal comprises a USB port, a keyboard, a touch screen panel, a wireless receiver, a Bluetooth receiver, and/or a port connecting to the internet.

4. The system of claim 3 wherein the operation control signal controls the operation of a plurality of storage, wherein the plurality of storages comprises the digitized music signal storage, the original score storage, and the played score storage.

5. The system of claim 4 wherein the operation control signal further controls the operation of the volume analyzer, the pitch analyzer, the tempo analyzer, the music notes recognizer, the performance analyzer, the music output interface, and the music display interface.

6. The system of claim 5 wherein the music display interface is used to display the original music score, the played music score, the overlay of the original music score and played music score showing difference between the original music score and the played music score, and the performance evaluation report.

7. A system for indicating music playing progress, comprising:
A. an input adapted for receiving a played music in analog form;
B. a real-time digital signal processing system adapted for converting the received played music to a played score, wherein the digital signal processing system comprises:
a. an A/D converter coupled to the input for converting the played music in the analog form to a digital form;
b. a signal storage for storing the played music in the digital form received from the A/D converter;
c. a volume analyzer adapted for extracting the amplitude information from the played music stored in the signal storage;
d. a pitch analyzer adapted for extracting the pitch information from the played music stored in the signal storage;
e. a tempo analyzer adapted for extracting the tempo information from the played music stored in the signal storage; and
f. a music note recognizer adapted for recognizing the music notes from the played music based on the information received from the volume analyzer, the pitch analyzer, and the tempo analyzer;
C. an original score storage adapted for storing an original music score;
D. a played score storage adapted for storing a played music score;
E. a progress comparator coupled to the original score storage, the played score storage for matching the played score to the original score and indicating the music playing progress through a progress indicator based on the information received from the volume analyzer, the pitch analyzer, and the tempo analyzer; and
F. a music display interface adapted for displaying the original score, the played score, and the music playing progress,
wherein the played music is received from the input, the played music is digitized by the A/D converter, processed by the volume analyzer, the pitch analyzer, and tempo analyzer, and the amplitude information, the pitch information and the tempo information extracted from the played music is sent to the music notes recognizer and played music score is obtained from an output of the music notes recognizer, and stored in the played score storage; and
wherein the played score is compared with the original score in real time based on the amplitude information, the pitch information and the tempo information extracted from the played music, and a music playing progress is displayed on the music display interface in real time.

8. The system of claim 7 wherein the digital signal processing system further comprises a CPU having a command input for receiving operation control signal, and wherein the CPU is coupled to the signal storage, the volume analyzer, the pitch analyzer, and the tempo analyzer, the music notes recognizer, the original score storage, the played score storage and the progress comparator.

9. The system of claim 8 wherein the sources of the operation control signal comprises a USB port, a keyboard, a touch screen panel, a wireless receiver, a Bluetooth receiver, and/or a port connecting to the internet.

10. The system of claim 9 wherein the operation control signal controls the operation of a plurality of storages, wherein the plurality of storages comprises the digitized music signal storage, the original score storage, and the played score storage.

11. The system of claim 10 wherein the operation control signal further controls the operation of the volume analyzer, the pitch analyzer, the tempo analyzer, the music notes recognizer, the progress comparator, and the music display interface.

12. The system of claim 11 wherein the music display interface is used to display the original score, the played score, and the music playing progress.

13. The system of claim 12 wherein the display of music playing progress comprises:
A. a moving bar displayed on top of the original score, or between the tremble notes and bass notes of the original score;
B. a flashing dots displayed on top of the original score, or between the tremble notes and bass notes of the original score; and
C. the played score.

14. The system of claim 13 wherein display of music playing progress can also be used as a trigger to automatically turn a sheet music page of the original score displayed on the music display interface.

15. A method for evaluating music performance, comprising the steps of:
A. recording a played music;
B. processing the played music to extracting the amplitude information, the pitch information and tempo information of the played music;
C. recognizing the music notes of the played music from the extracted the amplitude information, the pitch information and tempo information of the played music, wherein the music notes of the played music includes a played music score;
D. comparing the played music score with the original music score to obtain statistics of the performance; and
E. displaying the original music score, the played music score, the overlay of the original music score and played music score showing difference between the original music score and the played music score, and the performance evaluation report.

16. The method of claim 15, wherein the step of recording comprises the steps of:
A. receiving the played music in an analog form;
B. converting the received played music into a digital form; and
C. storing the converted played music.

17. The method of claim 15, further comprising the step of playing back the played music score or the original music score.

18. The method of claim 15, further comprising the step of storing the original music score of a selected music.

19. The method of claim 15, further comprising the step of displaying a music playing progress in real time by a progress indicator.

20. The method of claim 19, wherein the display of music playing progress comprises:
A. a moving bar displayed on top of the original score, or between the tremble notes and bass notes of the original score;
B. a flashing dots displayed on top of the original score, or between the tremble notes and bass notes of the original score; and
C. the played score.
